(19) United States
(12) Patent Application Publication
(10) Pub. No.: US 2013/0325539 A1
(43) Pub. Date: Dec. 5, 2013

(54) EVENT SCHEDULER SYSTEM AND METHOD

(71) Applicant: Frontline Technologies, Inc., Exton, PA (US)

(72) Inventors: Jeffrey T. FRITZ, Norristown, PA (US); Francis TAIT,, JR., Wayne, PA (US); Roland THOMPSON, West Chester, PA (US); Sean Michael TUCKER, Middletown, DE (US); Dennis Stephen BOHS, Thorndale, PA (US); Ralph Gershon JULIUS, West Chester, PA (US)

(73) Assignee: Frontline Technologies, Inc., Exton, PA (US)

(21) Appl. No.: 13/901,075

(22) Filed: May 23, 2013

Related U.S. Application Data
(60) Provisional application No. 61/653,670, filed on May 31, 2012.

(51) Int. Cl. G06Q 10/06

(52) U.S. Cl. CPC G06Q 10/063116
USPC 705/7.16

(57) ABSTRACT

A method, system, and program product, comprising: scheduling teacher evaluation events for teacher-evaluator pairs over a calendar date period to comply with compliance dates, comprising: selecting teachers evaluators to form a plurality of the teacher-evaluator pairs for teacher evaluation events, based on the teacher electronic calendars, evaluator calendars, teacher categories, and a time-table; scheduling respective dates and times for evaluation events over the course of the calendar period; changing the electronic calendars of the respective evaluators and the respective teachers to add the scheduled teacher evaluation events; running a software routine to wait for receipt of data indicating a new conflict event and changing date and/or time for evaluation events and/or forming new teacher-evaluator pairs; and changing the respective electronic calendars.

### CROSS-REFERENCE TO RELATED PATENT APPLICATIONS

This application claims priority from U.S. Provisional Application 61/653,670, filed May 31, 2012, which is incorporated herein by reference in its entirety as if fully set forth herein.

### BACKGROUND

A problem arises in scheduling events and modifying event schedules on the fly.

### SUMMARY OF EMBODIMENTS

A method, comprising: receiving or obtaining, using one or more computers, a time-table over a calendar date period of required compliance dates for respective teacher evaluation events to occur at or before respective compliance dates, the teacher evaluation events comprising at least one selected from the group of observation events, conference events, and evaluation submission events; accessing, using the one or more computers, in the performance of one or more of the following steps one or more databases stored on one or more computer-readable storage devices, the one or more databases comprising: teacher electronic calendars for a plurality of respective teachers, with multiple of the respective electronic calendars listing conflict periods, open periods and teaching periods; evaluator electronic calendars for a plurality of respective evaluators, with multiple of the respective electronic calendars listing conflict periods and open periods; teacher data including category data comprising respective categories for respective ones of the teachers; and the time-table over a calendar date period for teacher evaluation events; scheduling teacher evaluation events for teacher-evaluator pairs over a calendar date period in order to comply with one or more required compliance dates in the time-table for the respective teacher in the respective teacher-evaluator pair, the scheduling comprising: selecting, using the one or more computers, respective teachers from the plurality of teachers and respective evaluators from the plurality of evaluators, to form a plurality of the teacher-evaluator pairs for respective teacher evaluation events, the selecting for the respective teacher evaluation event based at least in part on the teacher electronic calendars, the evaluator calendars, the respective teacher categories for the respective teachers, and the time-table for teacher evaluation events for the respective teachers; scheduling respective dates and times, using the one or more computers, for the teacher evaluation events for the respective teachers over the course of the calendar date period, based at least in part on the conflict periods, open periods and teaching periods of the respective teacher and the open periods and the conflict periods of the respective evaluators, the respective teacher categories for the respective teachers, and based on complying with the required compliance dates in the time-table for the teacher evaluator events for the respective teacher; changing or having changed, using the one or more computers, the respective electronic calendars of the respective evaluators and the respective teachers to add the scheduled teacher evaluation events to the respective electronic calendars of the respective evaluators and the respective teachers, after receiving one or more acceptances for the respective scheduled teacher evaluation events; running a software routine on the one or more computers to wait for receipt of data indicating a new conflict event for one or both of the teacher and the evaluator in one or more respective teacher-evaluator pairs or a cancellation of a teaching period for the respective teacher in one or more of the respective teacher-evaluator pairs, and when the data for the new conflict event or cancellation is received, then determining if the conflict event or the cancellation of the teaching period coincides with an evaluation event, and if so, then changing either the date and/or time for one or more of the teacher evaluation events and/or forming one or more new teacher-evaluator pairs and scheduling a new date and time for one or more respective teacher evaluation events for the one or more new teacher-evaluator pairs to comply with the required compliance dates in the time-table; and changing or initiating changing, using the one or more computers, the respective electronic calendars of the respective one or more evaluators and the respective one or more teachers to reflect the respective changed dates and/or times for the one or more of the teacher evaluation events and/or adding information on the respective one or more dates and times for the respective scheduled teacher evaluation events for the one or more new teacher-evaluator pairs to the respective electronic calendars of the respective one or more evaluators and the respective one or more teachers in the one or more new teacher-evaluator pairs.

In embodiments, the software routine may be configured to make the changes to dates and/or times for one or more teacher evaluation events or schedules teacher evaluation events for new teacher-evaluator pairs and change the respective electronic calendars of the respective evaluators and the respective teachers, in real time.

In embodiments, the method may further comprise accessing at least data from the time table in the one or more databases and prioritizing within the calendar date period, using the one or more computers, the scheduling of respective teacher evaluation events based at least in part on providing priority to a respective teacher evaluation event where a current date is within a tolerance period occurring immediately before a required compliance date for the respective teacher evaluation event.

In embodiments, the method may further comprise accessing at least data the teacher category data in the one or more databases and prioritizing within the electronic calendar date period, using the one or more computers, the scheduling of respective teacher evaluation events based at least in part on providing priority to a respective teacher evaluation event for a respective one of the teachers based at least in part on the respective teacher category for the respective teacher.

In embodiments, the method may further comprise: accessing data from the teacher electronic calendars and the evaluator electronic calendars in the one or more databases and matching for each of multiple of the evaluators on the list, using the one or more computers, the schedule for the respective evaluator with the respective schedules for multiple of the different teachers over the school periods; determining, using the one or more computers, a number of school periods where both the respective evaluator and the respective teacher are open; and selecting, using the one or more computers, one of the teachers and one of the evaluators to comprise one of the teacher-evaluator pairs, based at least in part on the number of open periods that are concurrent for the respective teacher and the respective evaluator.

In embodiments, the method may further comprise: accessing data from the evaluator electronic calendars in the one or more databases and determining, using the one or more computers, for each of multiple of the evaluators, a number of school periods where the electronic calendar for the respective evaluator has a conflict; accessing data from the teacher electronic calendars in the one or more databases and determining, using the one or more computers, for each of multiple of the teachers, a number of school periods where the electronic calendar for the respective teacher has a conflict; and matching, using the one or more computers, one of the evaluators with a high number of school periods where there is a conflict, with one of the teachers with a low number of conflict periods, as compared to the high number of school periods where there is an evaluator conflict, to form an teacher-evaluator pair.

In embodiments, the method may further comprise: accessing data from the evaluator electronic calendars in the one or more databases and determining, using the one or more computers, for each of multiple of the evaluators, a number of school periods where the electronic calendar for the respective evaluator has a conflict within the tolerance period; accessing data from the teacher electronic calendars in the one or more databases and determining, using the one or more computers, for each of multiple of the teachers, a number of school periods within the tolerance period where the electronic calendar for the respective teacher has a conflict or a number of teaching periods where the teacher is teaching within the tolerance period; and matching, using the one or more computers, one of the evaluators with a high number of school periods where there is a conflict within the tolerance period, with one of the teachers with a low number of conflicts within the tolerance period as compared to the high number of school periods where there is an evaluator conflict, or for a teaching observation event to be scheduled, matching, using the one or more computers, one of the evaluators with a high number of school periods where there is a conflict within the tolerance period, with one of the teachers with a high number of teaching periods within the tolerance period as compared to the teaching period of other of the teachers to be observed during the tolerance period, to form an teacher-evaluator pair.

In embodiments, the method may further comprise: accessing data from the evaluator electronic calendars in the one or more databases and determining, using the one or more computers, for each of multiple of the evaluators, a number of school periods where the electronic calendar for the respective evaluator has a conflict within the tolerance period; accessing data from the teacher electronic calendars in the one or more databases and determining, using the one or more computers, for each of multiple of the teachers, a number of school periods within the tolerance period where the electronic calendar for the respective teacher has a conflict; determining an average or other representative number for evaluator conflicts within the tolerance period; determining an average or other representative number for teacher conflicts within the tolerance period; and matching evaluators with above average or representative number of evaluator conflicts with teachers with a below average or representative number of teacher conflicts to form an teacher-evaluator pair.

In embodiments, the method may further comprise the one or more computers configured to perform the matching using a bit map compare of the teacher periods in their respective teacher electronic calendars and evaluator periods in their respective evaluator electronic calendars.

In embodiments, the method may further comprise: the one or more computers configured with a disrupter algorithm to perform the matching step.

In embodiments, the method may further comprise: the one or more databases comprising room electronic calendar data listing open periods for the respective rooms and closed periods for the respective rooms; and wherein the scheduling step may comprise scheduling one or more of the evaluation events for multiple of the teacher-evaluator pairs to respective rooms based at least in part on the room electronic calendar data.

In embodiments, the selecting step to form the teacher-evaluator pairs may comprise the steps of accessing the one or more databases and making selections for the evaluator for a respective one of the teachers based at least in part on a preference to maintain the same evaluator with the respective teacher for multiple of the teacher evaluation events.

In embodiments, the method may further comprise: the one or more databases including preference information comprising respective teacher requests for one of the respective evaluators, and/or respective teachers requests to not be paired with one of the respective evaluators, and wherein the selecting respective teachers and respective evaluators to form a plurality of teacher-evaluator pairs step may comprise accessing the preference information on the teacher requests for a respective one of the evaluators and/or teacher requests not to be paired with a respective one of the evaluators and using this preference information as one factor in selecting the evaluator for a respective teacher.

In embodiments, the selecting step may form, using the one or more computers, multiple of the teacher-evaluator pairs based at least in part on matching subject matter taught by a respective one of the teachers during the calendar date period with one or more qualifications of the respective evaluator relating to that subject matter.

In embodiments, a method comprises: receiving or obtaining, using one or more computers, a time-table over a calendar date period of required compliance dates for respective teacher evaluation events to occur at or before respective compliance dates, the teacher evaluation events comprising at least one selected from the group of observation events, conference events, and evaluation submission events; receiving or obtaining, using the one or more computers, a list comprising a plurality of teacher-evaluator pairs, with each of the teacher-evaluator pairs comprising at least one teacher and at least one evaluator, wherein at least a given one of the teachers has a plurality of teacher-evaluator pairs, each with a different evaluator; accessing, using the one or more computers, in the performance of one or more of the following steps one or more databases stored on one or more computer-readable storage devices, the one or more databases comprising: teacher electronic calendars for a plurality of respective teachers, with multiple of the respective electronic calendars listing conflict periods, open periods and teaching periods; evaluator electronic calendars for a plurality of respective evaluators, with multiple of the respective calendars listing conflict periods and open periods; teacher data including category data comprising respective categories for respective ones of the teachers; and the time-table over a calendar date period for teacher evaluation events; selecting, using the one or more computers, for at least the given one of the teachers one of the teacher-evaluator pairs from among a plurality of teacher pairs for the given teacher for one of the teacher evaluation events, based at least in part on data on conflict periods, open periods and teaching periods from the teacher electronic calendar of the respective teacher, and data on conflict periods and open periods from the evaluator electronic calendar for the respective evaluator in the respective teacher-evaluator pair; scheduling respective dates and times, using the one or more computers, for the teacher evaluation events over the course of the calendar date period for each of multiple of the teacher-evaluator pairs, based at least in part on data on conflict periods, open periods and teaching periods from the teacher electronic calendar of the respective teacher, and data on conflict periods and open periods from the evaluator electronic calendar for the respective evaluator in the respective teacher-evaluator pair, and based at least in part on complying with the required compliance dates in the time-table, with a priority given to respective teacher evaluation events for respective teachers of at least one predetermined category at least if a current date is within a tolerance period occurring immediately before a required compliance date for the respective teacher evaluation event; receiving, using the one or more computers, acceptances for the scheduled teacher evaluation events; running a software routine on the one or more computers to wait for receipt of data indicating a new conflict event for one or both of the teacher or the evaluator in a respective teacher-evaluator pair or a cancellation of a teaching period for the respective teacher, and if the data for the new conflict event or cancellation is received, then determining if the conflict event or the cancellation of the teaching period coincides with an evaluation event, and if so, then proposing changing either the date and/or time for one or more of the teacher evaluation events and/or proposing forming one or more new teacher-evaluator pairs and scheduling a new date and time for one or more respective teacher evaluation events for the one or more new teacher-evaluator pairs to comply with the required compliance dates in the time-table; receiving, using the one or more computers, electronic acceptances for the proposed changed teacher evaluation events or for the proposed new teacher-evaluator pairs; and changing or initiating changing, using the one or more computers, the respective electronic calendars of the respective one or more evaluators and the respective one or more teachers to reflect the respective changed dates and/or times for one or more of the teacher evaluation events and/or adding information on the respective one or more dates and times for the respective scheduled teacher evaluation events for the one or more new teacher-evaluator pairs to the respective electronic calendars of the respective one or more evaluators and the respective one or more teachers in the one or more new teacher-evaluator pairs.

In embodiments, the scheduling step may further comprise double booking, using the one or more computers, a time period with one evaluator and at least a first and a second teachers, at least if the teacher evaluation events for these respective teachers cannot both be scheduled and a current date is within the tolerance period, the double booking comprising dividing the time period that is double booked into at least a first period portion and a second period portion, and scheduling the first teacher to the first period portion and the second teacher to the second period portion.

In embodiments, the one or more databases may be configured to receive and store completion data on respective evaluation events; and in embodiments, the method may further comprise: accessing the completion data in the one or more databases and monitoring for each of multiple of the evaluators, using the one or more computers, the completion data and the evaluation events for the respective evaluators; determining, using the one or more computers, compliance percentage data based at least in part on the completion data for the evaluation events for the respective evaluator relative to the teacher evaluation events to be performed by that one evaluator during the calendar date period, in order to comply with the time table of required compliance dates; and providing or making electronically accessible, using the one or more computers, data reflecting the compliance percentage data for electronic display or posting.

In embodiments, the one or more databases may be configured to receive and store completion data on respective evaluation events including a date of completion; and in embodiments the method may further comprise: accessing the completion data on one or more respective evaluation events including a date of completion for a respective one of the teachers; and generating, using the one or more computers, summary evaluation data for the respective one teacher, based at least in part on the completion data entered for the one or more of the teacher evaluation events for the respective one teacher including information on whether or not the date of completion for the respective teacher evaluation event occurred at or before the respective compliance date for that respective one teacher evaluation event.

In embodiments, the method may further comprise: selecting or receiving a selection, using the one or more computers, of a set of one or more goals for the respective teacher from a goals database, based at least in part on the summary evaluation data generated; generating, using the one or more computers, a schedule for achievement by the respective one teacher of the set of goals, wherein the one or more databases are configured to receive goal data including goal completion data for the set of goals; accessing the goal completion data in the one or more databases, using the one or more computers, to determine which of the set of one or more goals have been completed for the respective one teacher; and generating data for display or posting, using the one or more computers, listing the set of one or more goals for the respective one teacher and which of the one or more goals have been met or have not been met based at least in part on the data in the one or more databases.

In embodiments, a system is disclosed, comprising: one or more computers, configured with computer-readable program code to perform, when the program code is executed, the steps: receiving or obtaining, using the one or more computers, a time-table over a calendar date period of required compliance dates for respective teacher evaluation events to occur at or before respective compliance dates, the teacher evaluation events comprising at least one selected from the group of observation events, conference events, and evaluation submission events; accessing, using the one or more computers, in the performance of one or more of the following steps one or more databases stored on one or more computer-readable storage devices, the one or more databases comprising: teacher electronic calendars for a plurality of respective teachers, with multiple of the respective electronic calendars listing conflict periods, open periods and teaching periods; evaluator electronic calendars for a plurality of respective evaluators, with multiple of the respective electronic calendars listing conflict periods and open periods; teacher data including category data comprising respective categories for respective ones of the teachers; and the time-table over a calendar date period for teacher evaluation events; scheduling teacher evaluation events for teacher-evaluator pairs over a calendar date period in order to comply with one or more required compliance dates in the time-table for the respective teacher in the respective teacher-evaluator pair, the scheduling comprising: selecting, using the one or more computers, respective teachers from the plurality of teachers and respective evaluators from the plurality of evaluators, to form a plurality of the teacher-evaluator pairs for respective teacher evaluation events, the selecting for the respective teacher evaluation event based at least in part on the teacher electronic calendars, the evaluator calendars, the respective teacher categories for the respective teachers, and the time-table for teacher evaluation events for the respective teachers; scheduling respective dates and times, using the one or more computers, for the teacher evaluation events for the respective teachers over the course of the calendar date period, based at least in part on the conflict periods, open periods and teaching periods of the respective teacher and the open periods and the conflict periods of the respective evaluators, the respective teacher categories for the respective teachers, and based on complying with the required compliance dates in the time-table for the teacher evaluator events for the respective teacher; changing or having changed, using the one or more computers, the respective electronic calendars of the respective evaluators and the respective teachers to add the scheduled teacher evaluation events to the respective electronic calendars of the respective evaluators and the respective teachers, after receiving one or more acceptances for the respective scheduled teacher evaluation events; running a software routine on the one or more computers to wait for receipt of data indicating a new conflict event for one or both of the teacher and the evaluator in one or more respective teacher-evaluator pairs or a cancellation of a teaching period for the respective teacher in one or more of the respective teacher-evaluator pairs, and when the data for the new conflict event or cancellation is received, then determining if the conflict event or the cancellation of the teaching period coincides with an evaluation event, and if so, then changing either the date and/or time for one or more of the teacher evaluation events and/or forming one or more new teacher-evaluator pairs and scheduling a new date and time for one or more respective teacher evaluation events for the one or more new teacher-evaluator pairs to comply with the required compliance dates in the time-table; and changing or initiating changing, using the one or more computers, the respective electronic calendars of the respective one or more evaluators and the respective one or more teachers to reflect the respective changed dates and/or times for the one or more of the teacher evaluation events and/or adding information on the respective one or more dates and times for the respective scheduled teacher evaluation events for the one or more new teacher-evaluator pairs to the respective electronic calendars of the respective one or more evaluators and the respective one or more teachers in the one or more new teacher-evaluator pairs.

In embodiments, system is disclosed, comprising: one or more computers, configured with computer-readable program code to perform, when the program code is executed, the steps: receiving or obtaining, using one or more computers, a time-table over a calendar date period of required compliance dates for respective teacher evaluation events to occur at or before respective compliance dates, the teacher evaluation events comprising at least one selected from the group of observation events, conference events, and evaluation submission events; receiving or obtaining, using the one or more computers, a list comprising a plurality of teacher-evaluator pairs, with each of the teacher-evaluator pairs comprising at least one teacher and at least one evaluator, wherein at least a given one of the teachers has a plurality of teacher-evaluator pairs, each with a different evaluator; accessing, using the one or more computers, in the performance of one or more of the following steps one or more databases stored on one or more computer-readable storage devices, the one or more databases comprising: teacher electronic calendars for a plurality of respective teachers, with multiple of the respective electronic calendars listing conflict periods, open periods and teaching periods; evaluator electronic calendars for a plurality of respective evaluators, with multiple of the respective calendars listing conflict periods and open periods; teacher data including category data comprising respective categories for respective ones of the teachers; and the time-table over a calendar date period for teacher evaluation events; selecting, using the one or more computers, for at least the given one of the teachers one of the teacher-evaluator pairs from among a plurality of teacher pairs for the given teacher for one of the teacher evaluation events, based at least in part on data on conflict periods, open periods and teaching periods from the teacher electronic calendar of the respective teacher, and data on conflict periods and open periods from the evaluator electronic calendar for the respective evaluator in the respective teacher-evaluator pair; scheduling respective dates and times, using the one or more computers, for the teacher evaluation events over the course of the calendar date period for each of multiple of the teacher-evaluator pairs, based at least in part on data on conflict periods, open periods and teaching periods from the teacher electronic calendar of the respective teacher, and data on conflict periods and open periods from the evaluator electronic calendar for the respective evaluator in the respective teacher-evaluator pair, and based at least in part on complying with the required compliance dates in the time-table, with a priority given to respective teacher evaluation events for respective teachers of at least one predetermined category at least if a current date is within a tolerance period occurring immediately before a required compliance date for the respective teacher evaluation event; receiving, using the one or more computers, acceptances for the scheduled teacher evaluation events; running a software routine on the one or more computers to wait for receipt of data indicating a new conflict event for one or both of the teacher or the evaluator in a respective teacher-evaluator pair or a cancellation of a teaching period for the respective teacher, and if the data for the new conflict event or cancellation is received, then determining if the conflict event or the cancellation of the teaching period coincides with an evaluation event, and if so, then proposing changing either the date and/or time for one or more of the teacher evaluation events and/or proposing forming one or more new teacher-evaluator pairs and scheduling a new date and time for one or more respective teacher evaluation events for the one or more new teacher-evaluator pairs to comply with the required compliance dates in the time-table; receiving, using the one or more computers, electronic acceptances for the proposed changed teacher evaluation events or for the proposed new teacher-evaluator pairs; and changing or initiating changing, using the one or more computers, the respective electronic calendars of the respective one or more evaluators and the respective one or more teachers to reflect the respective changed dates and/or times for one or more of the teacher evaluation events and/or adding information on the respective one or more dates and times for the respective scheduled teacher evaluation events for the one or more new teacher-evaluator pairs to the respective electronic calendars of the respective one or more evaluators and the respective one or more teachers in the one or more new teacher-evaluator pairs.

### BRIEF DESCRIPTION OF THE DRAWINGS

The above and related objects, features and advantages of the present disclosure will be more fully understood by reference to the following detailed description, when taken in conjunction with the following figures, wherein:

FIG. 1 is a schematic block diagram of an embodiment of a system for generating multiple schedules, and for modifying schedules on the fly

FIG. 2 is a flowchart of a first embodiment of the invention.

FIG. 3 is a flowchart of a second embodiment of the invention.

FIG. 4 is a schematic diagram of a computer configuration that may be used to implement embodiments.

FIG. 5 is a screen shot of a teacher user interface that may be used for embodiments.

FIG. 6 is a screen shot of a evaluator user interface that may be used for embodiments.

FIG. 7 is a screen shot of an evaluator user interface that may be used for embodiments.

FIG. 8 is a screen shot of an administrator user interface that may be used for embodiments.

### DETAILED DESCRIPTION OF EMBODIMENTS

Embodiments described generally relate to a system, method and program product for an event scheduler for scheduling events and modifying events.

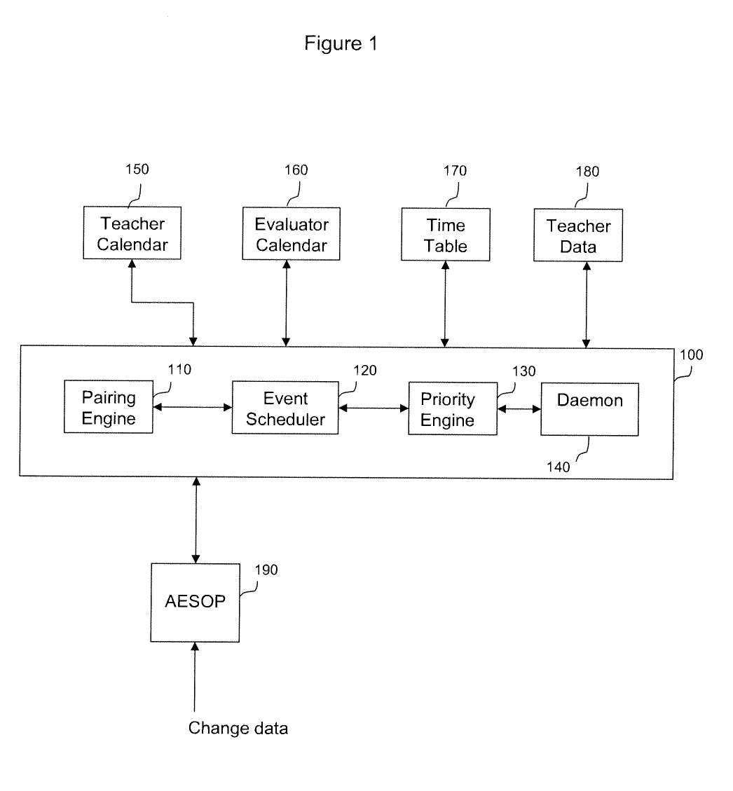

Referring to FIG. 1, an embodiment of a system is disclosed for performing event scheduling. A scheduling computer system 100 comprises one or more computers that are configured to comprise a pairing engine 110 to pair teachers and evaluators, and an event scheduler 120 to schedule events such as Preconference, Post conference, Observation 1, Observation 2, Classroom Evaluation, Formal Classroom Evaluation, Informal Observation, Ad-hoc Observation, Walk-Through, Summative, Peer Evaluation, Self-Evaluation, Staff Evaluation, Staff Assessment, Teacher Evaluation, Year End Evaluation, Interim Teacher Performance Evaluation, Annual Review, to name a few. Note that some of these events require observation during teaching, and some of these events do not. The computer system 100 further comprises a priority engine 130 for generating priority inputs to the scheduler engine, and a daemon or other software routine 140 for receiving/obtaining change information and re-scheduling evaluation events based at least in part on this change information. In embodiments, the one or more computers of the computer system 100 may configure one or more servers.

FIG. 1 further comprises one or more databases comprising a teacher calendar database 150, an evaluator calendar database 160, a time-table database 170, and a teacher information database 180, stored on one or more computer-readable storage devices either at one location or distributed across multiple locations.

FIG. 1 further comprises a connection to receive/obtain change information received from a teacher substitute engine, such as the Aesop (registered trademark) system of Frontline Placement Technologies, Inc.

The scheduler computer system 100 is configured with computer code to access, using the one or more computers, the one or more teacher calendar databases 150, the one or more evaluator calendar databases 160, the time-table database 170, and the teacher information database 180, in the performance of one or more of the operations of the pairing engine 110, the event scheduler 120, the priority engine 130, and the daemon software 140.

The teacher calendar database 150 comprises, in embodiments, the teacher electronic calendars for a plurality of respective teachers, with multiple of the respective electronic calendars listing conflict periods, open periods and teaching periods—eg: a French teacher needs to be evaluated when they are scheduled to be teaching the relevant subject—French. The evaluator calendar database 160 comprises, in embodiments, the evaluator electronic calendars for a plurality of respective evaluators, with the respective electronic calendars listing conflict periods and open periods. Note that the teacher calendar and the evaluator calendar may, in embodiments, include data from the school calendar, e.g., planned activities, days off, etc., in those calendars. However, in embodiments, the school calendar may be held in a separate database.

The time table database comprises, in embodiments, the time-table over a calendar date period for teacher evaluation events. In embodiments data for creating the time-table may be obtained from one or more sources, including federal rules, state Department of Education teacher evaluation rules, rules obtained from a teacher's union, rules obtained from a bargaining session with a teacher's union, rules of the local school board, to name a few. The teacher database comprises in embodiments, teacher data including for respective of the teachers, category data, e.g., a probationary category for new teachers that have only been on the job for less than a predetermined period of time, and/or teachers that have given warnings, level 1 certified teacher, level 2 certified teacher, master teacher, a tenured teacher category, or equivalents, to name a few.

The pairing engine 110 may comprise, in embodiments, one or more computers configured with programming code to select respective teachers from among a plurality of teachers and to select respective evaluators from among the plurality of evaluators, to form a plurality of the teacher-evaluator pairs for respective teacher evaluator events. In embodiments, the selecting for a respective teacher evaluation event may be based at least in part on one or more or all selected from the group: data such as a listing of conflict periods, open periods and teaching periods in the teacher electronic calendars; data such as a listing of open periods and conflict periods in the evaluator calendars; respective teacher categories for the respective teachers; and the time-table for teacher evaluation events for the respective teachers.

In embodiments, the pairing operation may be programmed to be restricted based on a requirement to use one from a predetermined one or more evaluators due to the category of the teacher and/or the type of evaluation event. For example, evaluations for teachers in a probationary category may be restricted to certain evaluators.

In embodiments, the pairing engine 110 may be programmed to form a pairing based at least in part on searching for and matching open periods for the respective teacher and the respective evaluator. In embodiments, the pairing engine 110 may form multiple pairings by, for each possible teacher-evaluator pair, searching for matching open periods. In such embodiments, a plurality of teacher-evaluator pairs may then be displayed to a respective one of the teachers, and/or a respective one of the evaluators, to allow a selection, in the case of a teacher, of the evaluator for the event, or in the case of the evaluator, a selection of the respective teacher for evaluation. As noted, the number of possible evaluators for a given teacher may be restricted due to the category of the teacher. In embodiments, the evaluators for a respective teacher may also be restricted because a priority may be set for that evaluator to evaluate another of the teachers, and/or that evaluator may have fewer available open periods.

The scheduling engine comprises, in embodiments, one or more computers configured to schedule respective dates and times for the teacher evaluation events for the respective teachers over the course of the calendar date period, based at least in part on the conflict periods, the open periods and the teaching periods of the respective teacher, and the open periods and the conflict periods of the respective evaluators, the teacher category for the respective teacher, and based at least in part on complying with the required compliance dates in the time-table for the teacher evaluation events for the respective teacher. In embodiments, the scheduling engine searches for matching open periods for the respective teacher-evaluator pair. In embodiments, certain teacher-evaluator pairs may be given priority due to the category of the teacher, and/or due to a restricted calendar with few open periods for the respective teacher or the respective evaluator.

In embodiments, the pairing engine 110 and the scheduling engine 120 may be separate operations. In embodiments, the pairing engine 110 and the scheduling engine 120 may be implemented in a single engine. In embodiments, the pairing engine 110 and/or the scheduling engine 120 may use a bit map compare algorithm to schedule the dates and times for evaluation events. In embodiments, the pairing engine 110 and/or the scheduling engine 120 may use a disruptor algorithm of the type disclosed by LMAX in the disclosure “DISTRUPTOR-CONCURRENT PROGRAMMING FRAMEWORK,” released Nov. 12, 2011 (http://code.google.com/p/disruptor/). See also the IDS filed with this application. In embodiments, the LMAX/Disruptor pattern may be used to manage the multi-threaded processing that the scheduling engine will use under load. Other algorithms in this area may be used include: SEDA, Publish/Subscribe and Locking Queues, to name a few.

In embodiments, after one or both of the teacher and the evaluator have been presented with the evaluation event to accept or reject, and have accepted the schedule for a respective one of the evaluation events, then in embodiments, the scheduling engine 120 may be configured to generate and transmit electronic data, using the one or more computers, to change or have changed the respective electronic calendars of the respective evaluator and the respective teacher in the teacher-evaluator pair to add the scheduled teacher evaluation event to the respective electronic calendars of the respective evaluator and the respective teacher.

In embodiments, a daemon or other software routine 140 may run on the one or more computers to wait for receipt of data indicating a new conflict event, e.g., a sick day or a vacation day for a teacher or for an evaluator in a respective teacher-evaluator pair, a snow day or power outage or other cause of a school closure, to name a few. When data for the new conflict event is received, then the daemon sends data and/or an instruction to cause the event scheduler engine 120 to change the date and/or time for one or more of the teacher evaluation events, and/or sends data and/or an instruction to cause the pairing engine 110 to form one or more new teacher-evaluator pairs and to cause the event scheduler engine 120 to schedule a new date and time for one or more respective teacher evaluation events for the one or more new teacher-evaluator pairs to comply with the required compliance dates in the time-table.

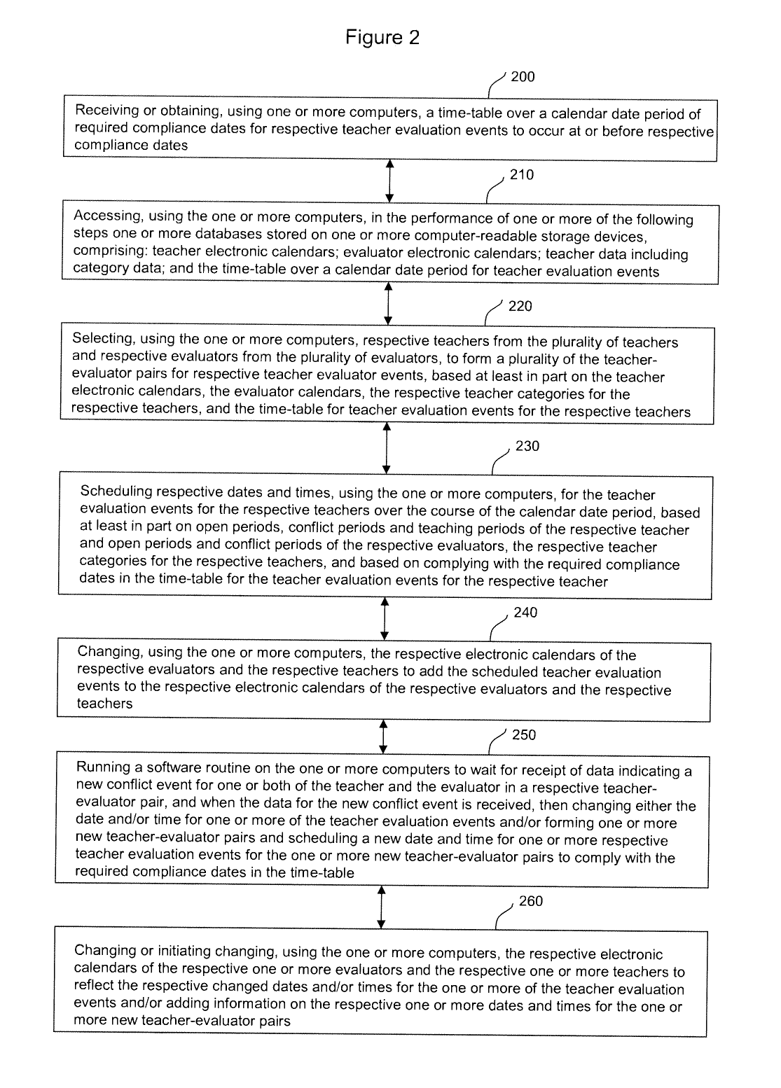

Referring to FIG. 2, embodiments of a method consistent with the invention is disclosed. In FIG. 2, block 200 comprises, in embodiments, receiving or obtaining, using the one or more computers, a time-table over a calendar date period, e.g., semester, year, to name a few, of required compliance dates for respective teacher evaluation events to occur at or before the respective compliance dates. As noted, in embodiments the teacher evaluation events may comprise at least one selected from the group of observation events, e.g., evaluator and peer, teacher-evaluator conference events, e.g., pre and post conference, and evaluation submission events. As noted, in embodiments the time-table may be obtained from one or more sources, including federal rules, state Department of Education teacher evaluation rules, rules obtained from a teacher's union, rules obtained from a bargaining session with a teacher's union, to name a few. The time-table may be obtained electronically over an electronic network via a transmission, or by accessing a website or other Internet location, or may be obtained by facsimile or by mail or hand-carried, and then keyed or scanned into the one or more databases. The manner of obtaining the time-table is not limiting on the invention. In embodiments, the system may comprise a step of generating the time-table based on inputs selected or obtained from various sources based on one or more criteria.

Block 210 comprises an operation of accessing, using the one or more computers, in the performance of one or more of the following steps one or more databases stored on one or more computer-readable storage devices. As noted, the one or more databases may comprises, in embodiments, one or more selected from the group of a teacher electronic calendars database 150 comprising the electronic calendars for a plurality of the respective teachers, with multiple of the respective electronic calendars listing conflict periods, open periods and teaching periods; an evaluator electronic calendars database 160 comprising the electronic calendars for a plurality of the respective evaluators, with multiple of the respective electronic calendars listing open periods and conflict periods; a teacher information database 180 including category data comprising respective categories, e.g., probationary, warning, tenured, level 1 certified teacher, level 2 certified teacher, master teacher, a tenured teacher category, or equivalents, to name a few, etc., for respective ones of the teachers; and the time-table database 170 over a calendar date period for teacher evaluation events. As noted, in some embodiments, a separate school calendar database may be present with planned activities, days off, etc., but this data in embodiments may be included in respective calendars of the teachers and the evaluators.

Block 220 comprises, in embodiments, an operation of selecting, using the one or more computers, respective teachers from the plurality of teachers and respective evaluators from the plurality of evaluators, to form a plurality of the teacher-evaluator pairs for respective teacher evaluator events, the selecting for the respective teacher evaluation event based at least in part on one or more selected from the group of: the teacher electronic calendars, the evaluator electronic calendars, the respective teacher categories for the respective teachers, and the time-table for teacher evaluation events for the respective teachers.

Block 230 comprises, in embodiments, an operation of scheduling respective dates and times, using the one or more computers, for the teacher evaluation events for the respective teachers over the course of the calendar date period, based at least in part on one or more selected from the group of: the conflict periods, the open periods and the teaching periods of the respective teacher, and the open periods and the conflict periods of the respective evaluators, the respective teacher categories for the respective teachers, and based on complying with the required compliance dates in the time-table for the teacher evaluator events for the respective teacher. As noted above, the pairing operation of block 220 and the scheduling operation of block 230 may be performed as one operation, or two operation, depending on the configuration of the software.

Note that in embodiments, a teacher-evaluator pair may be proposed electronically via posting to one or both of the respective teacher and the respective evaluator in the pair, via an email, text, or on their respective calendars, or other electronic notification. The respective teacher-evaluator pair would not be finalized until an acceptance had been received from one or both of the respective teacher and the respective evaluator. Likewise, the same process may be performed for date and time scheduling, wherein a date and a time may be proposed to one or both of the respective teacher and the respective evaluator in the pair, via an email, text, or on their respective calendars, or via other electronic notification. The respective date and time would not be finalized until an acceptance had been received from one or both of the respective teacher and the respective evaluator. In embodiments, this proposal-acceptance process for the pairing and the scheduling may be combined into a single process.

Block 240 comprises, in embodiments, an operation of changing or having changed, using the one or more computers, the respective electronic calendars of the respective evaluators and the respective teachers to add the scheduled teacher evaluation events to the respective electronic calendars of the respective evaluators and the respective teachers.

Block 250 comprises, in embodiments, an operation of running a software routine such as a daemon on the one or more computers to wait for receipt of data indicating a new conflict event, e.g., a sick day or a vacation day, or a snow day, or a power outage, or other unplanned school closure, to name a few, for one or both of the teacher and the evaluator in a respective teacher-evaluator pair or a cancellation of a teaching period for the respective teacher. When the data for the new conflict event or cancellation is received, then determining if the conflict event or the cancellation of the teaching period coincides with an evaluation event, and if so, then changing either the date and/or time for one or more of the teacher evaluation events to a new proposed date and/or time and/or forming one or more proposed new teacher-evaluator pairs and scheduling for electronic acceptance a proposed new date and time for one or more respective teacher evaluation events for the one or more new teacher-evaluator pairs to comply with the required compliance dates in the time-table. As noted above, in embodiments a new date and/or time or a new teacher-evaluator pair may be proposed electronically via posting to one or both of the respective teacher and the respective evaluator in the pair, via an email, text, or on their respective calendars, or other electronic notification. The respective new date and/or time or the new teacher-evaluator pair would not be finalized until an acceptance had been received from one or both of the respective teacher and the respective evaluator.

Block 260 comprises, in embodiments, an operation, upon receipt at the server of an acceptance of the change or the new evaluation event, of changing or initiating changing, using the one or more computers, the respective electronic calendars of the respective one or more evaluators and the respective one or more teachers to reflect the respective changed dates and/or times for the one or more of the teacher evaluation events and/or adding information on the respective one or more dates and times for the respective teacher evaluation events for the one or more new teacher-evaluator pairs to the respective electronic calendars of the respective one or more evaluators and the respective one or more teachers in the one or more new teacher-evaluator pairs. In embodiments, this operation may be programmed to be performed within an hour or within a day, or in some embodiments, in substantially real time, after receiving the change data.

As noted previously, in embodiments, a teacher-evaluator pair may be proposed to one or both of the respective teacher and the respective evaluator in the pair, via an email, text, or other electronic notification. The respective teacher-evaluator pair would not be finalized until an acceptance had been received from one or both of the respective teacher and the respective evaluator. Likewise, the same process may be performed for date and time scheduling, wherein a date and a time may be proposed to one or both of the respective teacher and the respective evaluator in the pair, via an email, text, or other electronic notification. The respective date and time would not be finalized until an acceptance had been received from one or both of the respective teacher and the respective evaluator. In embodiments, this proposal-acceptance process for the pairing and the scheduling may be combined into a single process.

In embodiments, the software routine 250 is configured to make the changes to dates and/or times for one or more teacher evaluation events or schedule teacher evaluation events for new teacher-evaluator pairs and change the respective electronic calendars of the respective evaluators and the respective teachers.

In embodiments, the selecting and scheduling operations may be configured to access at least data from the time table 170 in the one or more databases and to prioritize, using the one or more computers, the scheduling of respective teacher evaluation events based at least in part on providing priority to a respective teacher evaluation event where a current date is within a tolerance period occurring immediately before a required compliance date for the respective teacher evaluation event. The tolerance period may be any number of days or weeks or hours before a compliance date, e.g., 5 days, 10 days, 48 hours, 2 weeks, to name a few.

In embodiments, the selecting and scheduling operations may be configured to access at least the teacher category data in the one or more databases and to prioritize, using the one or more computers, the scheduling of respective teacher evaluation events based at least in part on providing priority to a respective teacher evaluation event for a respective one of the teachers based at least in part on the respective teacher category for the respective teacher. For example, pairing and/or scheduling priority may be provided for evaluation events for teacher categories such as new teachers during their initial probationary period, and/or for teachers that have been given performance warnings.

In embodiments, the selecting and scheduling operations may be configured to access data from the teacher electronic calendars and the evaluator electronic calendars in the one or more databases and to match for each of multiple of the evaluators on the list, using the one or more computers, the schedule for the respective evaluator with the respective schedules for multiple of the different teachers over the school periods, to determine, using the one or more computers, a number of school periods where both the respective evaluator and the respective teacher are open, and where a teaching observation event is scheduled, a teaching period of the relevant subject for the teacher. This embodiment may further comprise selecting, using the one or more computers, one of the teachers and one of the evaluators to comprise one of the teacher-evaluator pairs, based at least in part on the number of open periods that are concurrent for the respective teacher and/or the respective evaluator, or where a teaching observation event is scheduled, evaluator open periods during teaching periods of the relevant subject for the teacher.

In embodiments, the selecting operation may be configured to access data from the evaluator electronic calendars in the one or more databases and determine, using the one or more computers, for each of multiple of the evaluators, a number of school periods where the electronic calendar for the respective evaluator has a conflict. Using the one or more computers, for each of multiple of the teachers, the operation may further comprise accessing data from the teacher electronic calendars in the one or more databases and determining a number of school periods where the electronic calendar for the respective teacher has a conflict; or if for a teaching observation event, the number of teaching periods where the teacher is teaching the relevant subject. Then performing a matching operation, using the one or more computers, one of the evaluators with a high number of school periods where there is an evaluator conflict, e.g., 100, with one of the teachers with a low number of conflicts as compared to the evaluator's high number of school periods where there is a conflict, e.g., 50, to form an teacher-evaluator pair. Note that this process may be performed over the entire remaining period or only for a partial period, e.g., the next week, the next 10 days, the next month, to name a few. Alternatively, an average or other representative number for evaluator conflicts may be computed, and an average or other representative number for teacher conflicts may be computed, and evaluators with above average or representative number of evaluator conflicts may be paired with teachers with a below average or representative number of teacher conflicts. Where a teaching observation event is to be scheduled, matching, using the one or more computers, one of the evaluators with a high number of school periods where there is a conflict, e.g., 100, with one of the teachers with a high number of teaching periods as compared to the teaching period of other of the teachers to be observed, to form an teacher-evaluator pair. Alternatively, an average or other representative number for evaluator conflicts may be computed, and an average or other representative number for teacher teaching periods may be computed, and evaluators with above average or representative number of evaluator conflicts may be paired with teachers with an above average or representative number of teacher teaching periods

In embodiments, the selecting operation may be configured to access data from the evaluator electronic calendars in the one or more databases and determine, using the one or more computers, for each of multiple of the evaluators, a number of school periods within a tolerance period where the electronic calendar for the respective evaluator has a conflict, and to access data from the teacher electronic calendars in the one or more databases and determine, using the one or more computers, for each of multiple of the teachers, a number of school periods within the tolerance period where the electronic calendar for the respective teacher has a conflict, or for a teaching observation event, the number of teaching periods. Then a matching operation is performed for evaluations to be performed within the tolerance period, using the one or more computers, to match one of the evaluators with a high number of school periods where there is a conflict, e.g., 100, with one of the teachers with a low number of conflicts as compared to the evaluator's high number of school periods where there is an evaluator conflict, e.g., 50, to form a teacher-evaluator pair. Alternatively, an average or other representative number for evaluator conflicts within the tolerance period may be computed, and an average or other representative number for teacher conflicts within the tolerance period may be computed, and evaluators with above average or representative number of evaluator conflicts may be paired with teachers with a below average or representative number of teacher conflicts. Where a teaching observation event is to be scheduled within the tolerance period, matching, using the one or more computers, one of the evaluators with a high number of school periods where there is a conflict within the tolerance period, e.g., 100, with one of the teachers with a high number of teaching periods within the tolerance period as compared to the teaching period of other of the teachers to be observed during the tolerance period, to form an teacher-evaluator pair. Alternatively, an average or other representative number for evaluator conflicts within the tolerance period may be computed, and an average or other representative number for teacher teaching periods within the tolerance period may be computed, and evaluators with above average or representative number of evaluator conflicts may be paired with teachers with an above average or representative number of teacher teaching periods.

In embodiments, the one or more computers are configured to perform the matching open periods operation using a bit map compare of the teacher open periods in their respective teacher electronic calendars and evaluator open periods in their respective evaluator electronic calendars. In embodiments, the one or more computers are configured with the disrupter algorithm to perform the matching operation.

In embodiments, the one or more databases may further comprise room electronic calendar data listing open periods for the respective rooms and closed periods for the respective rooms. In embodiments, the scheduling step may comprise accessing this room electronic calendar data in the one or more databases and scheduling one or more of the evaluation events for multiple of the teacher-evaluator pairs to respective rooms based at least in part on the room electronic calendar data.

In embodiments, the selecting step to form the teacher-evaluator pairs may be configured to access data on prior teacher events or scheduled teacher events in the one or more databases and to make selections to form teacher-evaluator pairs based at least in part on a preference to maintain the same evaluator with the respective teacher for multiple of the teacher evaluation events.

In embodiments, the one or more databases may include preference information comprising respective teacher requests for one of the respective evaluators, and/or respective teachers requests to not be paired with one of the respective evaluators. In embodiments, the selecting respective teachers and respective evaluators to form a plurality of teacher-evaluator pairs step may access the preference information on the teacher requests for a respective one of the evaluators and/or teacher requests not to be paired with a respective one of the evaluators and may use this preference information as one factor in selecting an evaluator for a respective teacher.

In embodiments, the selecting of teachers and evaluators for teacher-evaluator pairs further comprises forming, using the one or more computers, multiple of the teacher-evaluator pairs based at least in part on matching subject matter taught by a respective one of the teachers during the calendar date period with one or more qualifications of the respective evaluator relating to that subject matter taught by the teacher.

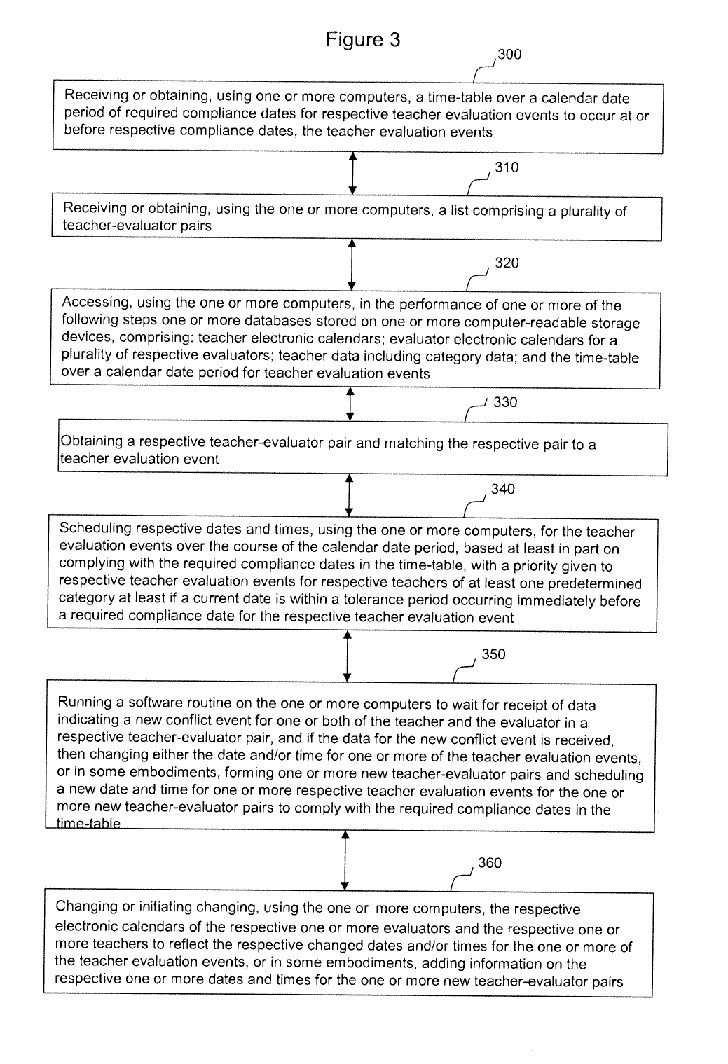

Referring to FIG. 3, a further embodiment of a method consistent with the present invention is disclosed. Block 300 comprises, in embodiments, receiving or obtaining, using one or more computers, a time-table over a calendar date period of required compliance dates for respective teacher evaluation events to occur at or before respective compliance dates, with the teacher evaluation events comprising at least one selected from the group of observation events, conference events, and evaluation submission events.

Block 310 comprises, in embodiments, receiving or obtaining, using the one or more computers, a list comprising a plurality of teacher-evaluator pairs, with each of the teacher-evaluator pairs comprising at least one teacher and at least one evaluator. Note that in some embodiments, each of the teachers may be paired with multiple different evaluators. For example, there may be a select group of evaluators for social studies. A given social studies teacher may be paired with each of the evaluators in the select group, so that the given teacher may have multiple teacher evaluator pairs. Note that in embodiments, one or more or all of these teacher-evaluator pairs may be pre-approved by the respective teacher and/or the respective evaluator. One of these teacher-evaluator pairs for the given teacher may then be selected in a subsequent step.

Block 320 comprises, in embodiments, accessing, using the one or more computers, in the performance of one or more of the following steps one or more databases stored on one or more computer-readable storage devices. The one or more databases may comprises, in embodiments, one or more selected from the group of: a teacher electronic calendars database 150 comprising the electronic calendars for a plurality of respective teachers, with multiple of the respective electronic calendars listing conflict periods, open periods and teaching periods; an evaluator electronic calendars database 160 comprising the electronic calendars for a plurality of respective evaluators, with multiple of the respective calendars listing open periods and conflict periods; a teacher data database 180 including category data comprising respective categories for respective ones of the teachers; a teacher-evaluator pairs database (not shown); and the time-table database 170 over a calendar date period for teacher evaluation events.

Block 330 comprises, an optional operation of selecting, using the one or more computers, for at least the given one of the teachers one of the teacher-evaluator pairs from among a plurality of teacher pairs for the given teacher for one of the teacher evaluation events, based at least in part on data on conflict periods, open periods and teaching periods from the teacher electronic calendar of the respective teacher, and data on conflict periods and open periods from the evaluator electronic calendar for the respective evaluator in the respective teacher-evaluator pair. In embodiments, this operation may include forming and/or accessing a database of teacher-evaluator pairs or generating a plurality of teacher-evaluator pairs for the given teacher on the fly.

Block 340 comprises, in embodiments, scheduling respective dates and times, using the one or more computers, for the teacher evaluation events over the course of the calendar date period for each of multiple of the teacher-evaluator pairs, based at least in part on data on conflict periods, open periods and teaching periods from the teacher electronic calendar of the respective teacher, and data on conflict periods and open periods from the evaluator electronic calendar for the respective evaluator in the respective teacher-evaluator pair, and based at least in part on complying with the required compliance dates in the time-table, with a priority given to respective teacher evaluation events for respective teachers of at least one predetermined category at least if a current date is within a tolerance period occurring immediately before a required compliance date for the respective teacher evaluation event.

Note that in embodiments, a process may be performed for date and time scheduling, wherein a date and a time may be proposed to one or both of the respective teacher and the respective evaluator in the pair, via an email, text, or other electronic notification or on their respective calendars. The respective date and time would not be finalized until an acceptance had been received from one or both of the respective teacher and the respective evaluator.

In embodiments, acceptances for the respective scheduled teacher evaluation events may be received at one or more servers, using the one or more computers. Block 350 comprises, in embodiments, such a receiving acceptances operation from the teachers and/or the evaluators.

Block 360 comprises, in embodiments, running a software routine on the one or more computers to wait for receipt of data indicating a new conflict event for one or both of the teacher and the evaluator in a respective teacher-evaluator pair or a cancellation of a teaching period for the respective teacher. When data for the new conflict event or cancellation is received, then determining if the conflict event or the cancellation of the teaching period coincides with an evaluation event, and if so, then changing the date and/or time for the teacher evaluation event and posting electronically a proposed change to the teacher and the evaluator for their acceptance. This posting may be to the respective calendars of the teachers and evaluators, or as noted via an email, text communication or other electronic method. In some embodiments, if a change of dates and/or times cannot be effected due to conflicts or other reasons, then forming a proposed new teacher-evaluator pair and scheduling a proposed new date and time for the respective teacher evaluation event with the new teacher-evaluator pair to comply with the required compliance dates in the time-table and posting electronically the change to the teacher and the evaluator for their acceptance.

Block 370 comprises, in embodiments, receiving on the server, using the one or more computers, electronic acceptances for the proposed changed teacher evaluation events or for the proposed new teacher-evaluator pairs and the proposed new date and time for the respective teacher evaluation event with the new teacher-evaluator pair.

Block 380 comprises, in embodiments, changing or initiating changing, using the one or more computers, the respective electronic calendars of the respective one or more evaluators and the respective one or more teachers to reflect the respective changed dates and/or times for one or more of the teacher evaluation events. In some embodiments, if a change of dates and/or times cannot be effected due to conflicts or other reasons, then adding information on the respective one or more dates and times for the respective scheduled teacher evaluation events for the one or more new teacher-evaluator pairs to the respective electronic calendars of the respective one or more evaluators and the respective one or more teachers in the one or more new teacher-evaluator pairs.

In embodiments, the scheduling operation 340 may further comprise double booking, using the one or more computers, a time period with one evaluator and at least a first and a second teachers. In embodiments, this double-booking may only be performed if the teacher evaluation events for these respective teachers cannot both be scheduled and a current date is within the tolerance period. The double booking may comprise in embodiments, dividing the time period that is double booked into at least a first period portion and a second period portion, and scheduling the first teacher to the first period portion and the second teacher to the second period portion.

In embodiments, the one or more databases are configured to receive and store completion data on respective evaluation events. Further steps may then be performed of accessing the completion data in the one or more databases and monitoring for each of multiple of the evaluators, using the one or more computers, the data on the completion data for the evaluation events for the respective evaluator. Then compliance percentage data may be determined or calculated, using the one or more computers, based at least in part on the completion data for the evaluation events for the respective evaluator relative to the teacher evaluation events to be performed by that one evaluator during the calendar date period, in order to comply with the time table of required compliance dates. This data reflecting the compliance percentage data may then be provided or made accessible, using the one or more computers, for electronic display or posting.

In embodiments, the one or more databases may be configured to receive and store completion data on respective evaluation events including a date of completion. In embodiments, summary evaluation data may be generated for one of the teachers by accessing the completion data on one or more of the respective evaluation events including a date of completion for the respective one teacher. Then using the one or more computers to generate the summary evaluation data for the respective one teacher, based at least in part on the data entered for at least one of the teacher evaluation events for the respective one teacher including information on whether or not the date of completion for the respective teacher evaluation event occurred at or before the respective compliance date for that respective one teacher evaluation event.

In embodiments, further steps may be performed of selecting or receiving a selection, using the one or more computers, of a set of one or more goals for the respective teacher from a goals database, based at least in part on the summary evaluation data generated. Then a step may be performed of generating, using the one or more computers, a schedule for achievement by the respective teacher of the set of goals. The one or more databases may be configured to receive goal data including goal completion data. Over the course of the evaluation period, the goal completion data in the one or more databases may be accessed, using the one or more computers, to determine which of the one or more goals have been completed for the respective teacher. Data derived from the goal completion data may then be generated for display or posting, using the one or more computers, listing the set of one or more goals for the respective teacher and which of the one or more goals have been met or have not been met based at least in part on the data in the one or more databases.

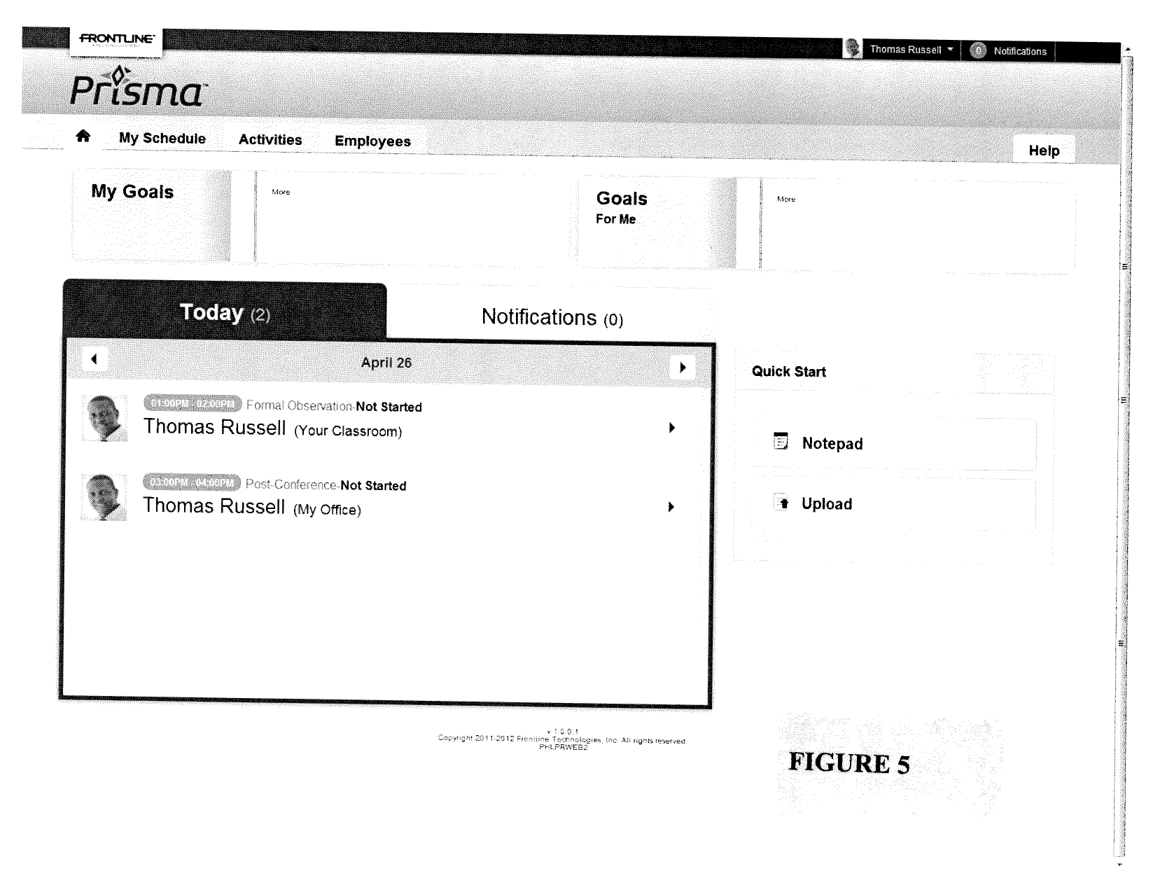

FIG. 5 comprises a screen shot of a Home page interface for a teacher comprising a listing 500 of evaluation events for April 26, with a designation indicating that a time for an evaluation event with Thomas Russell has been scheduled. A Formal Observation event is scheduled for 1:00 PM, and a Post-Conference is scheduled for 3:00 PM.

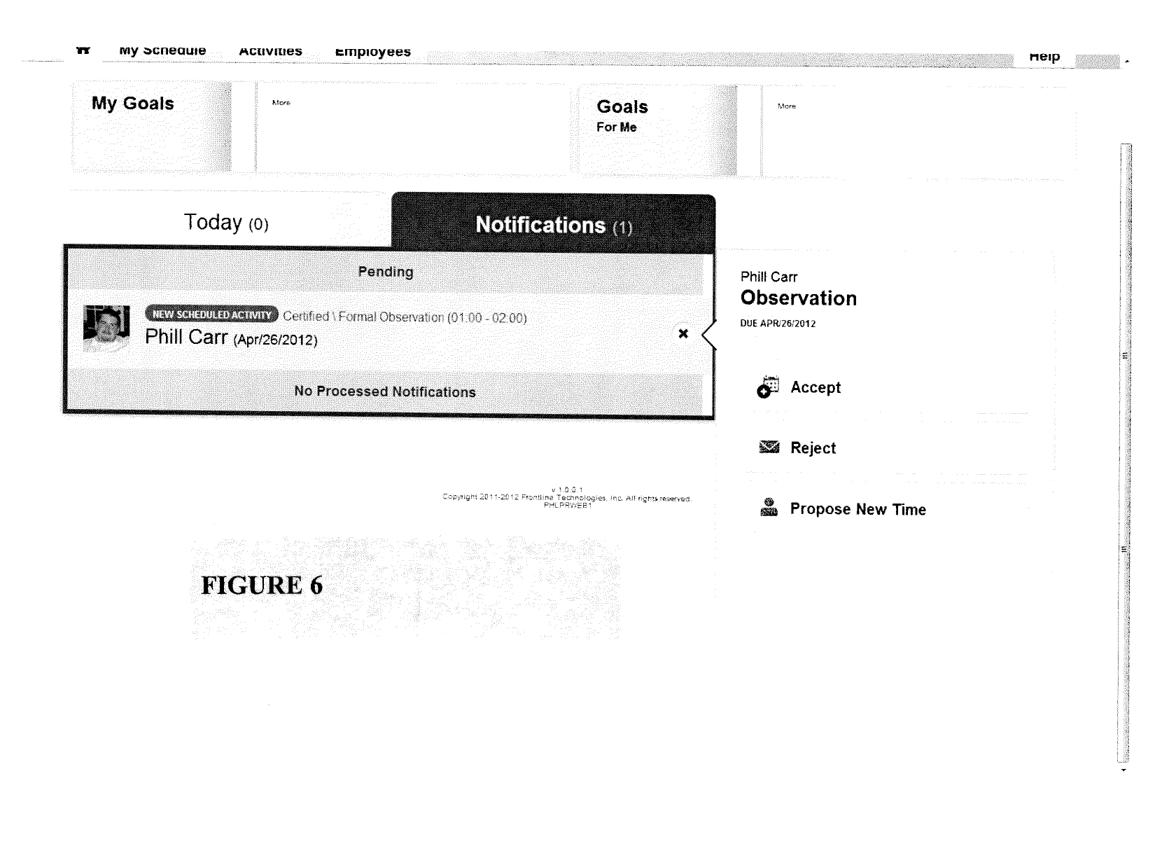

FIG. 6 is a screen shot of a Home page interface for evaluator Thomas Russell, with a New Notification that a Formal Observation event is proposed to be scheduled for 1:00 PM for teacher Phil Carr, with an Accept Button, a Reject Button and a Propose New Time Button on the right side of the screen shot.

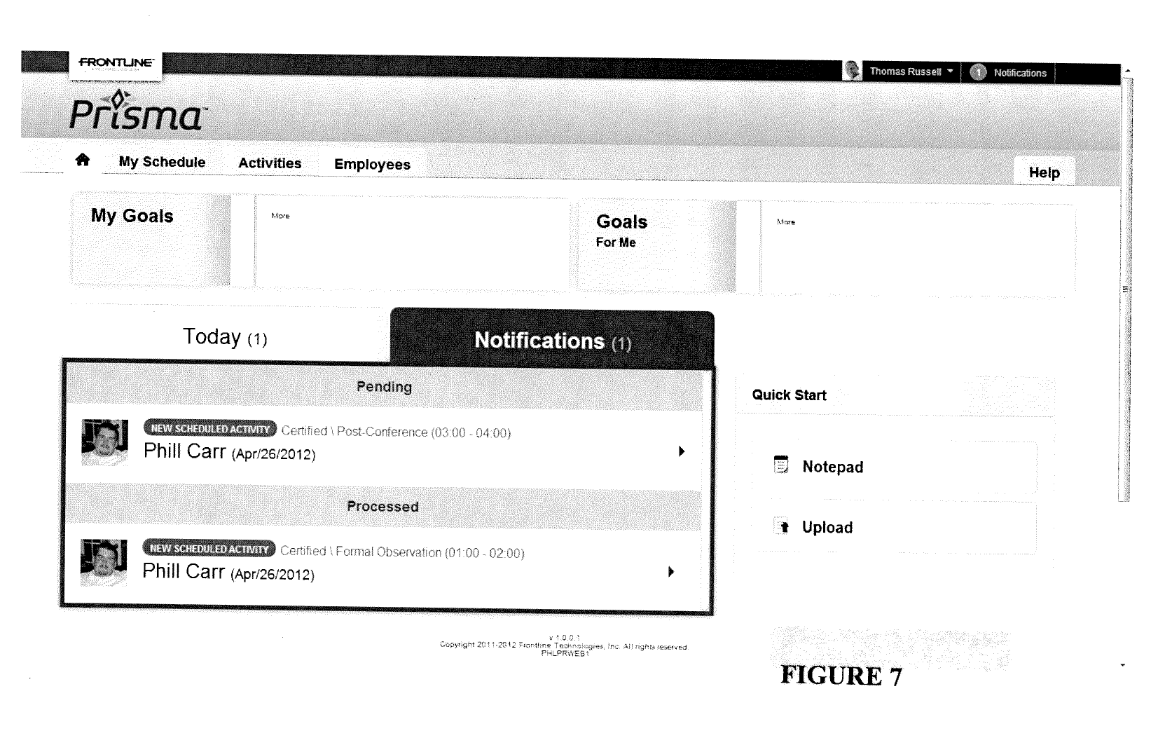

FIG. 7 comprises a screen shot of a Home page interface for evaluator Thomas Russell comprising a listing of evaluation events for April 26, with a designation indicating that a time for a Post-Conference event with teacher Phil Can scheduled for 3:00 PM that has not yet occurred, and a Formal Observation event with teacher Phil Can for 1:00 PM which has been accepted and scheduled by the system. On the right side of the slide is a Notepad for providing Formal Observation and Post-Conference information, and an Upload button.

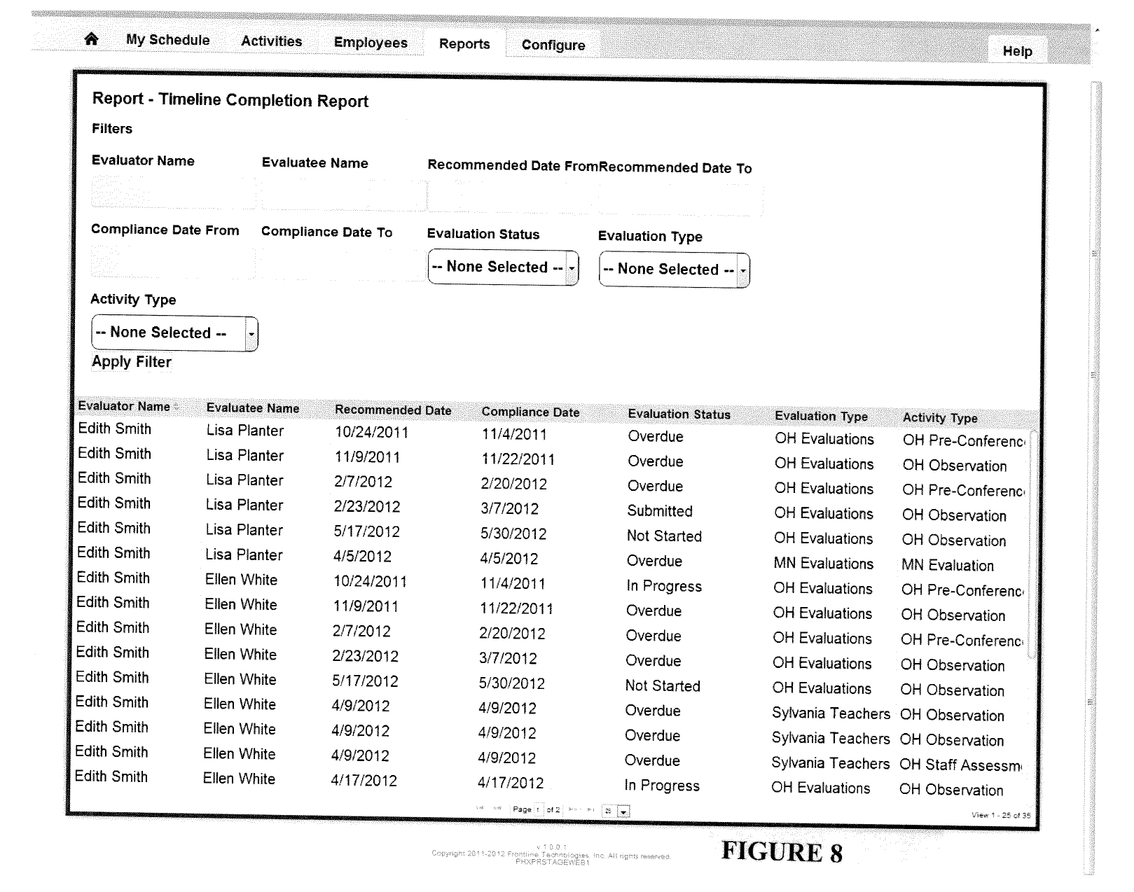

FIG. 8 is an administrator slide that illustrates a Timeline Completion Report for a specific evaluator, listing the evaluations that have been Submitted, and evaluations that are Overdue, e.g., are beyond the compliance date for that evaluation event, Not Started for evaluation events that are not yet overdue, and an In Progress listing for evaluation events being performed.

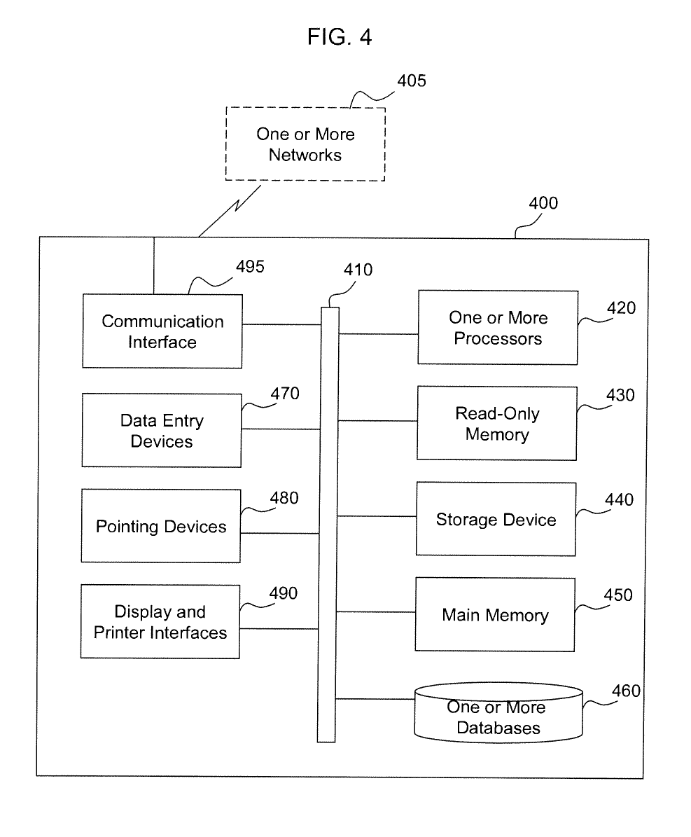

FIG. 4 is a block diagram illustrating an embodiment of a computer system that may be used for implementations, generally designated by reference number 400 in FIG. 4. In one embodiment, the system 400 may be communicatively coupled to one or more networks 405 via a communication interface 495. The one or more networks 405 may represent a generic network, which may correspond to a local area network (LAN), a wireless LAN, an Ethernet LAN, a token ring LAN, a wide area network (WAN), the Internet, a proprietary network, an intranet, a telephone network, a wireless network, to name a few, and any combination thereof. Depending on the nature of the network employed for a particular application, the communication interface 495 may be implemented accordingly. The network 405 serves the purpose of delivering information between connected parties.

In embodiments, the Internet may comprise the network 405. The system 400 may also or alternatively be communicatively coupled to a network 405 comprising a closed network (e.g., an intranet). The system 400 may be configured to communicate, via the one or more networks 405, with respective computer systems of multiple entities.

The system 400 may comprise, in embodiments, a computing platform for performing, controlling, and/or initiating computer-implemented operations, for example, via a server and the one or more networks 405. The computing platform may comprise system computers and other party computers. The system 400 may operate under the control of computer-executable instructions to carry out the process steps described herein. Computer-executable instructions comprise, for example, instructions and data which cause a general or special purpose computer system or processing device to perform a certain function or group of functions. Computer software for the system 400 may comprise, in embodiments, a set of software objects and/or program elements comprising computer-executable instructions collectively having the ability to execute a thread or logical chain of process steps in a single processor, or independently in a plurality of processors that may be distributed, while permitting a flow of data inputs/outputs between components and systems.

The system 400 may comprise one or more personal computers, workstations, notebook computers, servers, mobile computing devices, handheld devices, multi-processor systems, networked personal computers, minicomputers, mainframe computers, personal data assistants, Internet appliances (e.g., a computer with minimal memory, disk storage and processing power designed to connect to a network, especially the Internet, etc.), or controllers, to name a few.

The system 400 may comprise, in embodiments, a bus 410 or other communication component that couples the various system elements 420-495, and is configured to communicate information between the various system elements 420-495.

As shown in FIG. 4, one or more computer processors 420 may be coupled with the bus 410 and configured to process and handle information and execute instructions. The system 400 may include a main memory 450, such as a Random Access Memory (RAM) or other dynamic storage device, coupled to the bus 400, for storing information and instructions to be executed by the one or more processors 420. The main memory 450 also may be used for storing temporary variables or other intermediate information during execution of instructions by the one or more processors 420.

The system 400 further may include a Read-Only Memory (ROM) 430 or other static storage device (e.g., EPROM, EAROM, EEPROM, PROM, flash, and the like) coupled to the bus 410 for storing static information and instructions for the one or more processors 420. Furthermore, a storage device 440, such as a magnetic disk or optical disk, such as a CD-ROM or other optical media may be provided and coupled to the bus 410 for storing information and instructions.

In addition to the ROM 430, one or more databases 460 may be coupled to the bus 410 for storing static information and software instructions. In embodiments, information stored in or maintained in the database 460 may be provided in conformance with a database system format such as, but not limited to, the Structured Query Language (SQL) format. Database query and access instructions, for example, in the form of one or more scripts, may be used which, when executed by a processor such as the processor 420, serve to access, store and retrieve data maintained in the database 460 according to the instructions contained in the script.

Furthermore, the system 400 may comprise application software instructions which may implement a user interface portion for generating interactive pages or display screens by which a user may provide data to and receive information from the system 400 and the database 460 using a human-machine interface. Interactive pages may include user dialog boxes for accepting user entered information. In particular, the human-machine interface may comprise a Graphical User Interface (GUI) portion for prompting the user to enter data by providing an interactive dialog box or message box instructing the user to enter particular data, or to select from among a multitude of options provided using a pull-down menu. A user may interact with the system 400 via the graphical user interface by using a pointing device and/or data entry device. The GUI portion may place the output of the system 400 in a format for presentation to a user via the display. In at least one embodiment, the GUI may be implemented as a sequence of Java instructions.

A data entry device 470, including alphanumeric and other keys, or a pointing device such as a mouse or trackball, or a scanner, to name a few, may be coupled to the bus 410 for communicating information and command selections to the processor 420. The data entry device 470 may be coupled to the bus 410 via an interface (not shown), wherein the interface may be, for example, a serial port, an RS-232 port, or the like. In addition, the interface may be a wireless interface and provide connection-less communication via, for example, Bluetooth communication.

The system 400 may be coupled via the bus 410 to a display or printer 490 for outputting information to a computer user. In addition, a user may use the display (e.g., touch screen) or printer (e.g., scanner) to provide information to the system 400.

In embodiments, the various program operations as described herein may be provided by the system 400 in response to the one or more processors 420 executing one or more sequences of computer-readable instructions contained in the main memory 450. Such instructions may be read into the main memory 450 from another computer-readable medium, such as the ROM 430, the storage device 440, or the database 460. Execution of the sequences of instructions contained in the main memory 450 may cause the one or more processors 420 to perform the process steps described herein. It should be appreciated that embodiments of the system 400 may perform fewer or additional processes as compared to those described herein. As noted, the one or more processors 420 may be arranged in a multi-processing arrangement. Alternatively, hard-wired circuitry may be used in place of or in combination with software instructions to implement the invention. Thus, embodiments of the invention are not limited to any specific combination of hardware circuitry and software.

As previously noted, the system 400 also comprises a communication interface 495 coupled to the bus 410 for providing one-way, two-way or multi-way data communication with the network 405, or directly with other devices. In embodiments, the communication interface 495 may comprise a modem, a transceiver Integrated Services Digital Network (ISDN) card, a WAN card, an Ethernet interface, or the like, to provide a data communication connection to a corresponding type of communication medium. As another example, the communication interface 495 may comprise a LAN card to provide a data communication connection to a compatible LAN. Wireless links may also be implemented. In such wireless links, communication interface 495 may communicate with a base station communicatively coupled to a network server. In any such implementation, the communication interface 495 sends and receives electrical, electromagnetic, radio, infrared, laser, or optical signals that carry digital data streams representing various types of information. Any combination of the above interfaces may also be implemented.

In embodiments, the communication interface 495 may be communicatively coupled to a web server configured to generate and output web content that is suitable for display using a web browser at a computing device. In embodiments, the server may generate and transmit requested information through the communication interface 495 to a requesting terminal via Hypertext Transfer Markup Language (HTML) formatted pages, eXtensible Markup Language (XML) formatted pages, or the like, which may be provided as World Wide Web pages that may enable navigation by hyperlinks. The server program may be used to receive commands and data from the clients' terminals, access and process data from various sources, and output computer-executable instructions and data using the network 405.

The web server, in embodiments, may correspond to a secure web application server operating behind a web server program that a service provider employs to run one or more web based application programs to carry out the methods described above in a secure fashion. Such a secure web application server may be configured to execute one or more web based application programs, respond to commands and data received from the clients (via a web page supported by the web server), and provide data and results to the clients. The web server and the web application server may be implemented using a single computing platform. Alternatively, it may be implemented using multiple separate and distributed computing platforms.

Embodiments include program products comprising machine-readable media with machine-executable instructions or data structures stored thereon. Such machine-readable media may be any available storage media which can be accessed by a general purpose or special purpose computer or other machine with a processor. By way of example, such machine-readable storage media can comprise RAM, ROM, EPROM, EEPROM, CD-ROM or other optical disk storage, magnetic disk storage or other magnetic storage devices, or any other non-transitory storage medium which can be used to store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention have been described in the general context of method steps which may be implemented in embodiments by a program product including machine-executable instructions, such as program code, for example in the form of program modules executed by machines in networked environments. Generally, program modules include routines, programs, objects, components, data structures, etc., that perform particular tasks or implement particular data types. Multi-threaded applications may be used, for example, based on Java or C++. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced with one or multiple computers in a networked environment using logical connections to one or more remote computers (including mobile devices) having processors. Logical connections may include the previously noted local area network (LAN) and a wide area network (WAN) that are presented here by way of example and not limitation. Embodiments of the invention may also be practiced in distributed computing environments where tasks are performed by local and remote processing devices that are linked (either by hardwired links, wireless links, or by a combination of hardwired and wireless links) through a communications network. In a distributed computing environment, program modules may be located in both local and remote memory storage devices.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations. It should also be noted that the phrase “a plurality” is intended to mean more than one, and is not intended to refer to any previous recitation of the word “plurality,” unless preceded by the word “the.”

All components, modes of communication, and/or processes described heretofore are interchangeable and combinable with similar components, modes of communication, and/or processes disclosed elsewhere in the specification, unless an express indication is made to the contrary. It is intended that any structure or step of an embodiment disclosed herein may be combined with other structure and or method embodiments to form new embodiments with this added element or step.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

We claim:

1. A method, comprising:
receiving or obtaining, using one or more computers, a time-table over a calendar date period of required compliance dates for respective teacher evaluation events to occur at or before respective compliance dates, the teacher evaluation events comprising at least one selected from the group of observation events, conference events, and evaluation submission events;
accessing, using the one or more computers, in the performance of one or more of the following steps one or more databases stored on one or more computer-readable storage devices, the one or more databases comprising:
teacher electronic calendars for a plurality of respective teachers, with multiple of the respective electronic calendars listing conflict periods, open periods and teaching periods;
evaluator electronic calendars for a plurality of respective evaluators, with multiple of the respective electronic calendars listing conflict periods and open periods;
teacher data including category data comprising respective categories for respective ones of the teachers; and
the time-table over a calendar date period for teacher evaluation events;
scheduling teacher evaluation events for teacher-evaluator pairs over a calendar date period in order to comply with one or more required compliance dates in the time-table for the respective teacher in the respective teacher-evaluator pair, the scheduling comprising:
selecting, using the one or more computers, respective teachers from the plurality of teachers and respective evaluators from the plurality of evaluators, to form a plurality of the teacher-evaluator pairs for respective teacher evaluation events, the selecting for the respective teacher evaluation event based at least in part on the teacher electronic calendars, the evaluator calendars, the respective teacher categories for the respective teachers, and the time-table for teacher evaluation events for the respective teachers;
scheduling respective dates and times, using the one or more computers, for the teacher evaluation events for the respective teachers over the course of the calendar date period, based at least in part on the conflict periods, open periods and teaching periods of the respective teacher and the open periods and the conflict periods of the respective evaluators, the respective teacher categories for the respective teachers, and based on complying with the required compliance dates in the time-table for the teacher evaluator events for the respective teacher;
changing or having changed, using the one or more computers, the respective electronic calendars of the respective evaluators and the respective teachers to add the scheduled teacher evaluation events to the respective electronic calendars of the respective evaluators and the respective teachers, after receiving one or more acceptances for the respective scheduled teacher evaluation events;
running a software routine on the one or more computers to wait for receipt of data indicating a new conflict event for one or both of the teacher and the evaluator in one or more respective teacher-evaluator pairs or a cancellation of a teaching period for the respective teacher in one or more of the respective teacher-evaluator pairs, and when the data for the new conflict event or cancellation is received, then determining if the conflict event or the cancellation of the teaching period coincides with an evaluation event, and if so, then changing either the date and/or time for one or more of the teacher evaluation events and/or forming one or more new teacher-evaluator pairs and scheduling a new date and time for one or more respective teacher evaluation events for the one or more new teacher-evaluator pairs to comply with the required compliance dates in the time-table; and
changing or initiating changing, using the one or more computers, the respective electronic calendars of the respective one or more evaluators and the respective one or more teachers to reflect the respective changed dates and/or times for the one or more of the teacher evaluation events and/or adding information on the respective one or more dates and times for the respective scheduled teacher evaluation events for the one or more new teacher-evaluator pairs to the respective electronic calendars of the respective one or more evaluators and the respective one or more teachers in the one or more new teacher-evaluator pairs.

2. The method as defined in claim 1, wherein the software routine is configured to make the changes to dates and/or times for one or more teacher evaluation events or schedules teacher evaluation events for new teacher-evaluator pairs and change the respective electronic calendars of the respective evaluators and the respective teachers, in real time.

3. The method as defined in claim 1, further comprising:
accessing at least data from the time table in the one or more databases and prioritizing within the calendar date period, using the one or more computers, the scheduling of respective teacher evaluation events based at least in part on providing priority to a respective teacher evaluation event where a current date is within a tolerance period occurring immediately before a required compliance date for the respective teacher evaluation event.

4. The method as defined in claim 1, further comprising:
accessing at least data the teacher category data in the one or more databases and prioritizing within the electronic calendar date period, using the one or more computers, the scheduling of respective teacher evaluation events based at least in part on providing priority to a respective teacher evaluation event for a respective one of the teachers based at least in part on the respective teacher category for the respective teacher.

5. The method as defined in claim 1, further comprising:
accessing data from the teacher electronic calendars and the evaluator electronic calendars in the one or more databases and matching for each of multiple of the evaluators on the list, using the one or more computers, the schedule for the respective evaluator with the respective schedules for multiple of the different teachers over the school periods;
determining, using the one or more computers, a number of school periods where both the respective evaluator and the respective teacher are open; and
selecting, using the one or more computers, one of the teachers and one of the evaluators to comprise one of the teacher-evaluator pairs, based at least in part on the number of open periods that are concurrent for the respective teacher and the respective evaluator.

6. The method as defined in claim 1, further comprising:
accessing data from the evaluator electronic calendars in the one or more databases and determining, using the one or more computers, for each of multiple of the evaluators, a number of school periods where the electronic calendar for the respective evaluator has a conflict;
accessing data from the teacher electronic calendars in the one or more databases and determining, using the one or more computers, for each of multiple of the teachers, a number of school periods where the electronic calendar for the respective teacher has a conflict; and
matching, using the one or more computers, one of the evaluators with a high number of school periods where there is a conflict, with one of the teachers with a low number of conflict periods, as compared to the high number of school periods where there is an evaluator conflict, to form an teacher-evaluator pair.

7. The method as defined in claim 1, further comprising:
accessing data from the evaluator electronic calendars in the one or more databases and determining, using the one or more computers, for each of multiple of the evaluators, a number of school periods where the electronic calendar for the respective evaluator has a conflict within the tolerance period;
accessing data from the teacher electronic calendars in the one or more databases and determining, using the one or more computers, for each of multiple of the teachers, a number of school periods within the tolerance period where the electronic calendar for the respective teacher has a conflict or a number of teaching periods where the teacher is teaching within the tolerance period; and
matching, using the one or more computers, one of the evaluators with a high number of school periods where there is a conflict within the tolerance period, with one of the teachers with a low number of conflicts within the tolerance period as compared to the high number of school periods where there is an evaluator conflict, or for a teaching observation event to be scheduled, matching, using the one or more computers, one of the evaluators with a high number of school periods where there is a conflict within the tolerance period, with one of the teachers with a high number of teaching periods within the tolerance period as compared to the teaching period of other of the teachers to be observed during the tolerance period, to form an teacher-evaluator pair.

8. The method as defined in claim 1, further comprising:
accessing data from the evaluator electronic calendars in the one or more databases and determining, using the one or more computers, for each of multiple of the evaluators, a number of school periods where the electronic calendar for the respective evaluator has a conflict within the tolerance period;
accessing data from the teacher electronic calendars in the one or more databases and determining, using the one or more computers, for each of multiple of the teachers, a number of school periods within the tolerance period where the electronic calendar for the respective teacher has a conflict; and
determining an average or other representative number for evaluator conflicts within the tolerance period;
determining an average or other representative number for teacher conflicts within the tolerance period; and
matching evaluators with above average or representative number of evaluator conflicts with teachers with a below average or representative number of teacher conflicts to form an teacher-evaluator pair.

9. The method as defined in claim 1, further comprising:
the one or more computers configured to perform the matching using a bit map compare of the teacher periods in their respective teacher electronic calendars and evaluator periods in their respective evaluator electronic calendars.

10. The method as defined in claim 1, further comprising:
the one or more computers configured with a disrupter algorithm to perform the matching step.

11. The method as defined in claim 1, further comprising:
the one or more databases comprising room electronic calendar data listing open periods for the respective rooms and closed periods for the respective rooms; and
wherein the scheduling step comprises scheduling one or more of the evaluation events for multiple of the teacher-evaluator pairs to respective rooms based at least in part on the room electronic calendar data.

12. The method as defined in claim 1, wherein the selecting step to form the teacher-evaluator pairs comprises the steps of accessing the one or more databases and making selections for the evaluator for a respective one of the teachers based at least in part on a preference to maintain the same evaluator with the respective teacher for multiple of the teacher evaluation events.

13. The method as defined in claim 1, further comprising:
the one or more databases including preference information comprising respective teacher requests for one of the respective evaluators, and/or respective teachers requests to not be paired with one of the respective evaluators, and
wherein the selecting respective teachers and respective evaluators to form a plurality of teacher-evaluator pairs step comprises accessing the preference information on the teacher requests for a respective one of the evaluators and/or teacher requests not to be paired with a respective one of the evaluators and using this preference information as one factor in selecting the evaluator for a respective teacher.

14. The method as defined in claim 1, wherein the selecting step forms, using the one or more computers, multiple of the teacher-evaluator pairs based at least in part on matching subject matter taught by a respective one of the teachers during the calendar date period with one or more qualifications of the respective evaluator relating to that subject matter.

15. A method, comprising:
receiving or obtaining, using one or more computers, a time-table over a calendar date period of required compliance dates for respective teacher evaluation events to occur at or before respective compliance dates, the teacher evaluation events comprising at least one selected from the group of observation events, conference events, and evaluation submission events;
receiving or obtaining, using the one or more computers, a list comprising a plurality of teacher-evaluator pairs, with each of the teacher-evaluator pairs comprising at least one teacher and at least one evaluator, wherein at least a given one of the teachers has a plurality of teacher-evaluator pairs, each with a different evaluator;
accessing, using the one or more computers, in the performance of one or more of the following steps one or more databases stored on one or more computer-readable storage devices, the one or more databases comprising:
teacher electronic calendars for a plurality of respective teachers, with multiple of the respective electronic calendars listing conflict periods, open periods and teaching periods;
evaluator electronic calendars for a plurality of respective evaluators, with multiple of the respective calendars listing conflict periods and open periods;
teacher data including category data comprising respective categories for respective ones of the teachers; and
the time-table over a calendar date period for teacher evaluation events;
selecting, using the one or more computers, for at least the given one of the teachers one of the teacher-evaluator pairs from among a plurality of teacher pairs for the given teacher for one of the teacher evaluation events, based at least in part on data on conflict periods, open periods and teaching periods from the teacher electronic calendar of the respective teacher, and data on conflict periods and open periods from the evaluator electronic calendar for the respective evaluator in the respective teacher-evaluator pair;
scheduling respective dates and times, using the one or more computers, for the teacher evaluation events over the course of the calendar date period for each of multiple of the teacher-evaluator pairs, based at least in part on data on conflict periods, open periods and teaching periods from the teacher electronic calendar of the respective teacher, and data on conflict periods and open periods from the evaluator electronic calendar for the respective evaluator in the respective teacher-evaluator pair, and based at least in part on complying with the required compliance dates in the time-table, with a priority given to respective teacher evaluation events for respective teachers of at least one predetermined category at least if a current date is within a tolerance period occurring immediately before a required compliance date for the respective teacher evaluation event;
receiving, using the one or more computers, acceptances for the scheduled teacher evaluation events;
running a software routine on the one or more computers to wait for receipt of data indicating a new conflict event for one or both of the teacher or the evaluator in a respective teacher-evaluator pair or a cancellation of a teaching period for the respective teacher, and if the data for the new conflict event or cancellation is received, then determining if the conflict event or the cancellation of the teaching period coincides with an evaluation event, and if so, then proposing changing either the date and/or time for one or more of the teacher evaluation events and/or proposing forming one or more new teacher-evaluator pairs and scheduling a new date and time for one or more respective teacher evaluation events for the one or more new teacher-evaluator pairs to comply with the required compliance dates in the time-table;
receiving, using the one or more computers, electronic acceptances for the proposed changed teacher evaluation events or for the proposed new teacher-evaluator pairs; and
changing or initiating changing, using the one or more computers, the respective electronic calendars of the respective one or more evaluators and the respective one or more teachers to reflect the respective changed dates and/or times for one or more of the teacher evaluation events and/or adding information on the respective one or more dates and times for the respective scheduled teacher evaluation events for the one or more new teacher-evaluator pairs to the respective electronic calendars of the respective one or more evaluators and the respective one or more teachers in the one or more new teacher-evaluator pairs.

16. The method as defined in claim 15, wherein the scheduling step further comprises double booking, using the one or more computers, a time period with one evaluator and at least a first and a second teachers, at least if the teacher evaluation events for these respective teachers cannot both be scheduled and a current date is within the tolerance period, the double booking comprising dividing the time period that is double booked into at least a first period portion and a second period portion, and scheduling the first teacher to the first period portion and the second teacher to the second period portion.

17. The method as defined in claim 15, wherein the one or more databases are configured to receive and store completion data on respective evaluation events; and
further comprising:
accessing the completion data in the one or more databases and monitoring for each of multiple of the evaluators, using the one or more computers, the completion data and the evaluation events for the respective evaluators;
determining, using the one or more computers, compliance percentage data based at least in part on the completion data for the evaluation events for the respective evaluator relative to the teacher evaluation events to be performed by that one evaluator during the calendar date period, in order to comply with the time table of required compliance dates; and
providing or making electronically accessible, using the one or more computers, data reflecting the compliance percentage data for electronic display or posting.

18. The method as defined in claim 15, wherein the one or more databases are configured to receive and store completion data on respective evaluation events including a date of completion; and
further comprising:
accessing the completion data on one or more respective evaluation events including a date of completion for a respective one of the teachers; and
generating, using the one or more computers, summary evaluation data for the respective one teacher, based at least in part on the completion data entered for the one or more of the teacher evaluation events for the respective one teacher including information on whether or not the date of completion for the respective teacher evaluation event occurred at or before the respective compliance date for that respective one teacher evaluation event.

19. The method as defined in claim 15, further comprising:
selecting or receiving a selection, using the one or more computers, of a set of one or more goals for the respective teacher from a goals database, based at least in part on the summary evaluation data generated;
generating, using the one or more computers, a schedule for achievement by the respective one teacher of the set of goals,
wherein the one or more databases are configured to receive goal data including goal completion data for the set of goals;
accessing the goal completion data in the one or more databases, using the one or more computers, to determine which of the set of one or more goals have been completed for the respective one teacher; and
generating data for display or posting, using the one or more computers, listing the set of one or more goals for the respective one teacher and which of the one or more goals have been met or have not been met based at least in part on the data in the one or more databases.

20. A system, comprising:
one or more computers, configured with computer-readable program code to perform, when the program code is executed, the steps:
receiving or obtaining, using the one or more computers, a time-table over a calendar date period of required compliance dates for respective teacher evaluation events to occur at or before respective compliance dates, the teacher evaluation events comprising at least one selected from the group of observation events, conference events, and evaluation submission events;
accessing, using the one or more computers, in the performance of one or more of the following steps one or more databases stored on one or more computer-readable storage devices, the one or more databases comprising:
teacher electronic calendars for a plurality of respective teachers, with multiple of the respective electronic calendars listing conflict periods, open periods and teaching periods;
evaluator electronic calendars for a plurality of respective evaluators, with multiple of the respective electronic calendars listing conflict periods and open periods;
teacher data including category data comprising respective categories for respective ones of the teachers; and
the time-table over a calendar date period for teacher evaluation events;
scheduling teacher evaluation events for teacher-evaluator pairs over a calendar date period in order to comply with one or more required compliance dates in the time-table for the respective teacher in the respective teacher-evaluator pair, the scheduling comprising:
selecting, using the one or more computers, respective teachers from the plurality of teachers and respective evaluators from the plurality of evaluators, to form a plurality of the teacher-evaluator pairs for respective teacher evaluation events, the selecting for the respective teacher evaluation event based at least in part on the teacher electronic calendars, the evaluator calendars, the respective teacher categories for the respective teachers, and the time-table for teacher evaluation events for the respective teachers;
scheduling respective dates and times, using the one or more computers, for the teacher evaluation events for the respective teachers over the course of the calendar date period, based at least in part on the conflict periods, open periods and teaching periods of the respective teacher and the open periods and the conflict periods of the respective evaluators, the respective teacher categories for the respective teachers, and based on complying with the required compliance dates in the time-table for the teacher evaluator events for the respective teacher;
changing or having changed, using the one or more computers, the respective electronic calendars of the respective evaluators and the respective teachers to add the scheduled teacher evaluation events to the respective electronic calendars of the respective evaluators and the respective teachers, after receiving one or more acceptances for the respective scheduled teacher evaluation events;
running a software routine on the one or more computers to wait for receipt of data indicating a new conflict event for one or both of the teacher and the evaluator in one or more respective teacher-evaluator pairs or a cancellation of a teaching period for the respective teacher in one or more of the respective teacher-evaluator pairs, and when the data for the new conflict event or cancellation is received, then determining if the conflict event or the cancellation of the teaching period coincides with an evaluation event, and if so, then changing either the date and/or time for one or more of the teacher evaluation events and/or forming one or more new teacher-evaluator pairs and scheduling a new date and time for one or more respective teacher evaluation events for the one or more new teacher-evaluator pairs to comply with the required compliance dates in the time-table; and
changing or initiating changing, using the one or more computers, the respective electronic calendars of the respective one or more evaluators and the respective one or more teachers to reflect the respective changed dates and/or times for the one or more of the teacher evaluation events and/or adding information on the respective one or more dates and times for the respective scheduled teacher evaluation events for the one or more new teacher-evaluator pairs to the respective electronic calendars of the respective one or more evaluators and the respective one or more teachers in the one or more new teacher-evaluator pairs.

21. A system, comprising:
one or more computers, configured with computer-readable program code to perform, when the program code is executed, the steps:
receiving or obtaining, using one or more computers, a time-table over a calendar date period of required compliance dates for respective teacher evaluation events to occur at or before respective compliance dates, the teacher evaluation events comprising at least one selected from the group of observation events, conference events, and evaluation submission events;
receiving or obtaining, using the one or more computers, a list comprising a plurality of teacher-evaluator pairs, with each of the teacher-evaluator pairs comprising at least one teacher and at least one evaluator, wherein at least a given one of the teachers has a plurality of teacher-evaluator pairs, each with a different evaluator;
accessing, using the one or more computers, in the performance of one or more of the following steps one or more databases stored on one or more computer-readable storage devices, the one or more databases comprising:
teacher electronic calendars for a plurality of respective teachers, with multiple of the respective electronic calendars listing conflict periods, open periods and teaching periods;
evaluator electronic calendars for a plurality of respective evaluators, with multiple of the respective calendars listing conflict periods and open periods;
teacher data including category data comprising respective categories for respective ones of the teachers; and
the time-table over a calendar date period for teacher evaluation events;
selecting, using the one or more computers, for at least the given one of the teachers one of the teacher-evaluator pairs from among a plurality of teacher pairs for the given teacher for one of the teacher evaluation events, based at least in part on data on conflict periods, open periods and teaching periods from the teacher electronic calendar of the respective teacher, and data on conflict periods and open periods from the evaluator electronic calendar for the respective evaluator in the respective teacher-evaluator pair;
scheduling respective dates and times, using the one or more computers, for the teacher evaluation events over the course of the calendar date period for each of multiple of the teacher-evaluator pairs, based at least in part on data on conflict periods, open periods and teaching periods from the teacher electronic calendar of the respective teacher, and data on conflict periods and open periods from the evaluator electronic calendar for the respective evaluator in the respective teacher-evaluator pair, and based at least in part on complying with the required compliance dates in the time-table, with a priority given to respective teacher evaluation events for respective teachers of at least one predetermined category at least if a current date is within a tolerance period occurring immediately before a required compliance date for the respective teacher evaluation event;
receiving, using the one or more computers, acceptances for the scheduled teacher evaluation events;
running a software routine on the one or more computers to wait for receipt of data indicating a new conflict event for one or both of the teacher or the evaluator in a respective teacher-evaluator pair or a cancellation of a teaching period for the respective teacher, and if the data for the new conflict event or cancellation is received, then determining if the conflict event or the cancellation of the teaching period coincides with an evaluation event, and if so, then proposing changing either the date and/or time for one or more of the teacher evaluation events and/or proposing forming one or more new teacher-evaluator pairs and scheduling a new date and time for one or more respective teacher evaluation events for the one or more new teacher-evaluator pairs to comply with the required compliance dates in the time-table;
receiving, using the one or more computers, electronic acceptances for the proposed changed teacher evaluation events or for the proposed new teacher-evaluator pairs; and
changing or initiating changing, using the one or more computers, the respective electronic calendars of the respective one or more evaluators and the respective one or more teachers to reflect the respective changed dates and/or times for one or more of the teacher evaluation events and/or adding information on the respective one or more dates and times for the respective scheduled teacher evaluation events for the one or more new teacher-evaluator pairs to the respective electronic calendars of the respective one or more evaluators and the respective one or more teachers in the one or more new teacher-evaluator pairs.
